(19) United States
(12) Patent Application Publication
(10) Pub. No.: US 2004/0103115 A1
(43) Pub. Date: May 27, 2004

(54) System and method of protecting digital content

(76) Inventors: Eric J. Vandewater, Scottsdale, AZ (US); Peter Jacobs, Phoenix, AZ (US)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(21) Appl. No.: 10/304,259

(22) Filed: Nov. 26, 2002

(51) Int. Cl. G06F 7/00

(52) U.S. Cl. 707/104.1; 707/1

(57) ABSTRACT

A digital recordation of content such as a compact disc includes a first audio session containing a work in a first digital file format as well as a second data session containing the same work in an alternative digital file format. The second data session also includes an executable program that installs software on a personal computer that is intended to frustrate accurate digital audio extraction of information from the first audio session, while directing the computer user to the content that is provided on the second data session. The content on the second data session is preferably controlled by a digital rights management protocol in order to prevent widespread unlicensed sharing of the content.

### BACKGROUND OF THE INVENTION

1. Field of the Invention

This invention relates generally to the field of digital recordation and distribution of protected content of works such as audio compositions and video productions. More specifically, this invention relates to an improved system and method of protecting such digital content from unlawful copying and distribution by using a personal computer.

2. Description of the Related Technology

The widespread use of personal computers and Internet access has permitted extensive unauthorized digital extraction, reproduction and distribution of a significant amount of artistic content, including audio, video, software, images and text. Significant contributing factors to this unauthorized distribution include the large volume of digital content that has been made available to consumers in formats such as audio CD, CD-ROM, CD-R, DVD and DVD-R media and the ease of digital extraction and duplication of the music or other content on these physical media. Unfortunately, the standards used to produce the content for audio CDs (e.g., the IEC 60908 Redbook Standard) were not originally intended to prevent transfer of the content in digital or analog form and do not use methods to conceal the digital data on the CD for preventing unauthorized transfer. Further, copies made using digital processes are of high quality. Even copies using compressed formats such as, for example the standard MPEG Audio Layer 3 (MP3) format or Microsoft's Windows® Media (WMA) format, are of good quality in comparison to prior analog copying approaches.

The music industry in particular has a strong interest in protecting its proprietary works from unauthorized copying and distribution, especially over the Internet or through other computer-based copying and distribution using music ripping software or other techniques. A number of attempts have been made by the music industry to provide music CDs that can be reliably played in consumer CD players but that somehow are resistant to digital audio extraction by a personal computer. Although there has been some success in this area, anything less than 100 percent playability by the wide array of consumer CD players that are already in use is extremely undesirable. When a consumer purchases a new CD he or she expects it to play in his or her equipment, and there is a great amount of anger and frustration if it does not. The record industry is extremely reluctant to take the rest of this happening to its end consumers who appropriately purchase its music offerings. In addition, the reliability of protection against unauthorized copying and other digital extraction provided by the techniques that have been so far developed by the industry has been haphazard, being highly dependent upon specific hardware characteristics, firmware versions and countermeasures that have been employed by various forms of software. Another disadvantage of such technology is that it prevents a consumer who has legitimately purchased a compact disc from playing music files from the compact disc using his or her computer. Many consumers who purchase music on compact discs expect to be able to play them on their computers, or at least to extract the music to their hard drives using software that contains a digital rights management protocol, such as Windows Media Player.®

A need exists for an improved system and method for protecting digital content that does not adversely affect playability, that reliably prevents unauthorized duplication of digital content and that furthermore provides consumers in opportunity to play music that they have purchased on their personal computers.

### SUMMARY OF THE INVENTION

Accordingly, it is an object of the invention to provide an improved system and method for protecting digital content that does not adversely affect playability, that reliably prevents unauthorized duplication of digital content and that furthermore provides consumers in opportunity to play music that they have purchased on their personal computers.

In order to achieve the above and other objects of the invention, a digital recordation of content that is provided according to a first aspect of the invention includes a a first session containing a work, the first session being provided in a first digital format; and a second session also containing the work, the second session being provided in a second digital format that is different than the first digital format.

A method of operating a personal computer according to a second aspect of the invention includes steps of determining whether a digital recordation of content that is readable by a hardware device in the personal computer is protected; monitoring a data stream between the hardware device and a top-level software program; and if the digital recordation of content is determined to be protected, returning incorrect information to the top-level software program in response to a request for digital information from the digital recordation of content.

According to a third aspect of the invention, a method of operating a personal computer includes steps of determining whether a digital recordation of content that is readable by a hardware device in the personal computer contains protected material; and if the digital recordation of content is determined to be protected, directing the personal computer to an alternative source of the content that is protected by a digital rights management protocol.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a diagrammatical depiction of a digital recordation of content constructed according to a preferred embodiment of the invention;

FIG. 2 is a logical map of the digital recordation of content that is depicted in FIG. 1;

FIGS. 3A and 3B are a flow chart depicting a process of operating a personal computer according to a preferred embodiment of the invention;

FIG. 4 is an example of data that may be requested from the digital recordation of content by a top-level software program;

FIG. 5 is an example of incorrect data that may be provided to the top-level software program according to one aspect of the invention; and

FIG. 6 is a flow chart depicting an alternative portion of the process depicted in FIGS. 3A and 3B.

### DETAILED DESCRIPTION OF THE PREFERRED EMBODIMENT(S)

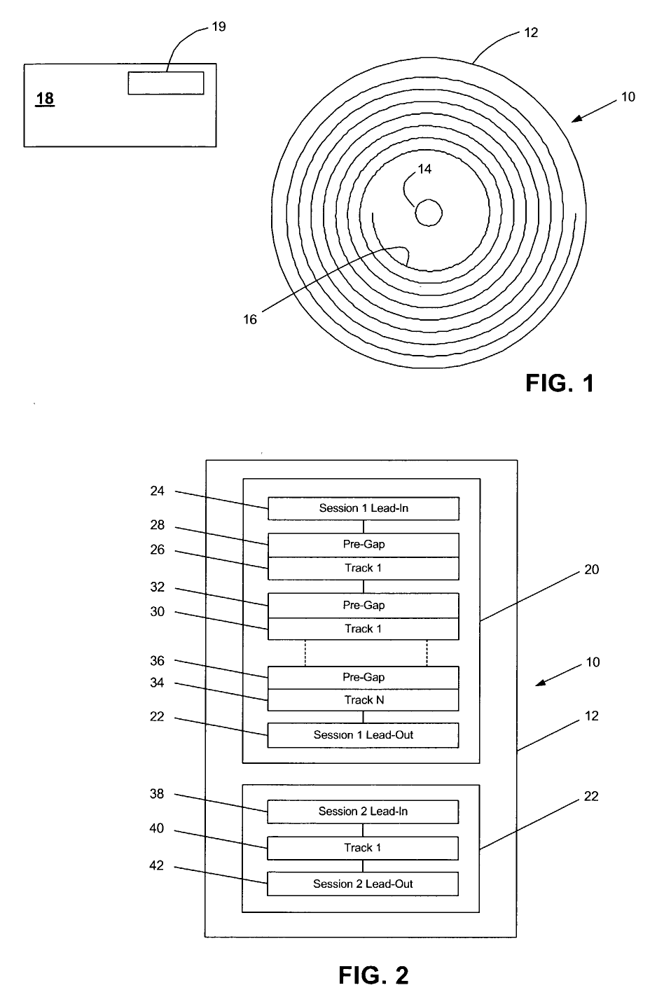

Referring now to the drawings, wherein like reference numerals designate corresponding structure throughout the views, and referring in particular to FIG. 1, a digital recordation of content 10 that is constructed according to a preferred embodiment of the invention is preferably embodied as a compact disc or CD 12 which, according to industry standard specifications, includes a center hole 14 and a continuous track 16 that is arranged in a helical pattern around the center hole 14. Information on a compact disc is recorded in a plurality of optically readable marks in a format that is specified by one or more industry standards. For example, data information is specified by what is commonly referred to as the Yellow Book standard, while audio information is provided a format that is specified by the Red Book standard. The information is typically pressed into the material from which the compact discs made, forming embossed pits and lands between the pits, each of which represents a single unit of binary or digital information.

Although in the preferred embodiment of the invention the digital recordation of content 10 is embodied as a compact disc, it should be understood that a digital recordation of content could alternatively take the form of a digital versatile disc or DVD, optical or magnetic digital tape, a hard drive, or any of a plurality of possible types of portable digital media, such as memory sticks, high-capacity magnetic storage cartridges or wireless remote storage options.

Also shown schematically in FIG. 1 is a personal computer 18 that has installed therein a hardware device for reading the digital recreation of content 10. In the preferred embodiment, the hardware device is a CD-ROM drive 19 that is capable of reading information from the compact disc 12. Alternatively, the hardware device could be a DVD ROM drive, a magnetic or optical tape reader or any other type of hardware that is appropriate for reading the digital recordation of content 10 that may be selected within the broad scope of the invention.

Referring now to FIG. 2, which is a logical map of the compact disc 12 shown in FIG. 1, it will be seen that the compact disc 12 is formatted as a multisession compact disc, having a first audio session 20 and a second data session 22. It will be seen that the first audio session 20 includes a lead in portion 24, which according to industry specifications includes a table of contents identifying the specific sectors on the compact disc 12 on which particular information within the first session 20 is contained. For example, the table of contents will include information as to the physical position on the compact disc 12 of a first audio track 26, and of subsequent audio tracks. The table of contents will also contain information that will alert the personal computer 18 of the presence of the second, data session 22.

As is further shown in FIG. 2, first session 20 further includes the first audio track 26 briefly discussed above. As is standard in the industry, first audio track 26 contains a pre-gap portion 28, which is typically a two second period of silence at the beginning of the audio track 26. Similarly, first audio session 20 includes a second audio track 30 also having a pre-gap area 32 and a plurality of additional audio tracks as may be required to record a desired audio work, terminating with a final audio track 34, also having a pre-gap area 36.

The second data session 22 also includes a lead in area 38 containing a table of contents and at least one data track 40, the contents of which will be describing greater detail below. The second data session 22 terminates with a lead out area 42.

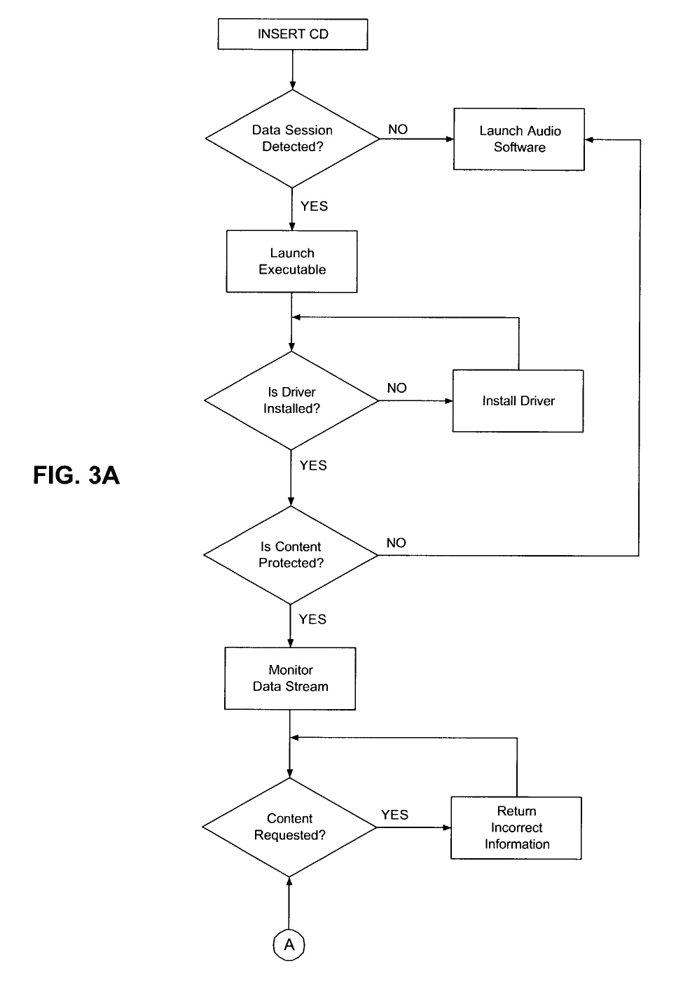

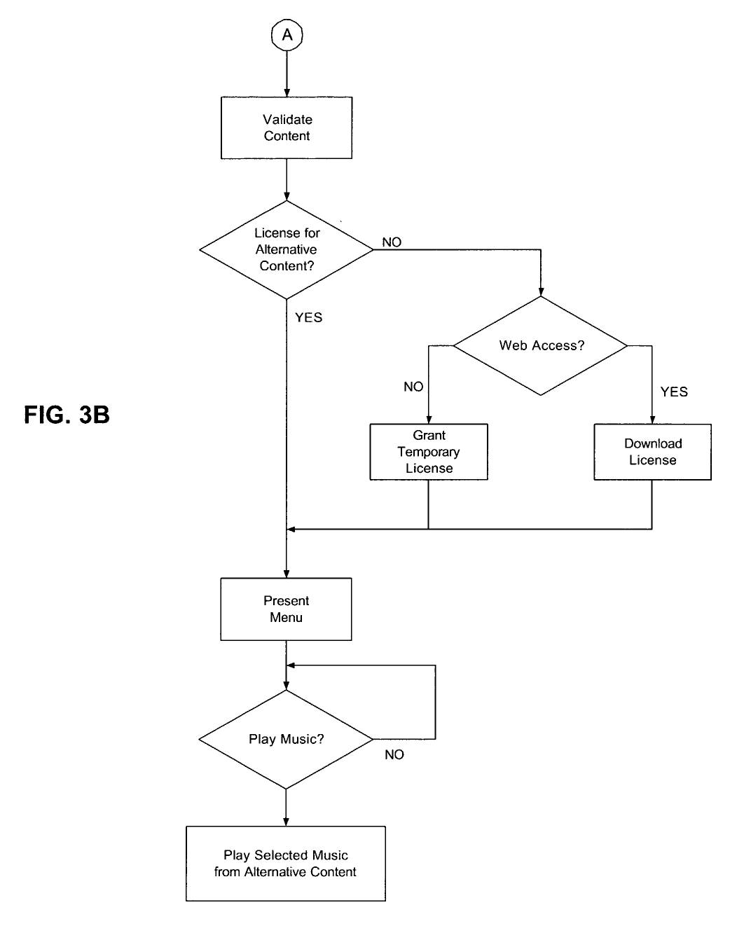

Preferably, the data track 40 includes a plurality of data files, including a file that instructs the personal computer 18 to automatically execute an executable or program file. In a Windows operating environment, the file that instructs the personal computer to automatically execute the program file is typically an .inf file format. Referring now to FIG. 3A, it will be seen that when a compact disc 12 is inserted into the CD ROM drive 19 of the personal computer 18 the operating system will detect whether or not a data session is present. If a data session is not detected, such as when a regular audio compact disc is inserted into the CD ROM drive 19, the operating system of the personal computer 18 will automatically launch software, such as Windows Media Player®, to play the files in the audio session as is conventional given the current state of the industry.

If, however, a data session is detected, and the data session is the second session 22 described above with reference to FIG. 2, the operating system will be instructed to launch an executable program file. The executable program will first inquire as to whether a specialized driver according to one important aspect of the invention has been installed in the personal computer 18. If the executable program determines that the driver has in fact not been installed, it will, preferably automatically, install the driver itself. Optionally, the executable program may inquire of the operator as to whether permission is given for installation of software, which would include the specialized driver.

After installation of the driver, the driver will periodically poll the CD ROM drive 19 and any additional CD ROM or DVD ROM drives as to whether a digital recordation of content 10 is present containing content that is protected according to the invention. This may be done on a session by session basis or on an audio track by audio track basis, according to possible alternative embodiments of the invention. Preferably, the digital recordation of content 10 is encoded to indicate whether or not content recorded thereon is protected. In one embodiment of the invention that is depicted in FIG. 6, a specific digital code is provided in the pre-gap area of each audio track to indicate whether or not the audio content contained on that audio track is protected. By encoding the pre-gap area, the integrity of the work that is recorded on the audio track is not in any way affected by the presence of this additional data. Alternatively, the presence of protected content on the compact disc 12 could be indicated to the personal computer 18 and specifically the specialized driver by any one of a number of different techniques, such as by searching for a particular file in the second data session, reviewing the size of a particular file, performing a check sum on a particular file or numbers of files, or looking for data within one or more particular files or within a predetermined sector or sectors. Specifically, a digital code could be added to the table of contents, to one of the P-W subchannels, to a reserved area on the yellow book session, or in the lead-out.

If the specialized driver determines that there is no protected content, the default audio software may be launched by the operating system of the personal computer 18, and the content contained within the audio tracks of the compact disc may be played normally without interference from the specialized driver. In the embodiment of the invention that shown in FIG. 6, where each audio track is checked for protected content, the default audio software may be permitted to access data from nonprotected tracks without interference from the specialized driver while data from protected tracks will be prevented from reaching the default audio software intact, as will be described in greater detail below.

Once protected content is detected on the digital recordation of content 10 the specialized driver, the specialized driver will monitor the data stream between the hardware device in which the digital recordation of content 10 is installed, which in the preferred embodiment is the CD ROM drive 19, and any software application running on the personal computer 18 that may request information from the protected content. In the preferred embodiment, the specialized driver monitors the low-level SCSI command set instructions that are given to the CD ROM drive 19. When a software application such as those that are typically used to “rip” or create compressed digital audio files such as MP3s attempt to access the digital information that is contained on a protected audio track, the specialized driver will detect this request on the SCSI command level and, instead of returning the requested information will return incorrect information to the software application. This incorrect information may be accurate information from a sector other than the sector from which the information was requested, completely random information, or the requested information upon which additional information has been superimposed. For example, the requested information could be returned with additional superimposed encoding that will have the effect of providing periodic unpleasant noises such as beeps or a prerecorded voice indicating that protected content is being requested. Preferably, the information that is returned by the specialized driver to the software application is returned in such a way that the software application will not be able to detect that anything other than the requested information has been provided. As a result, it will be difficult to employ effective countermeasures within the software application.

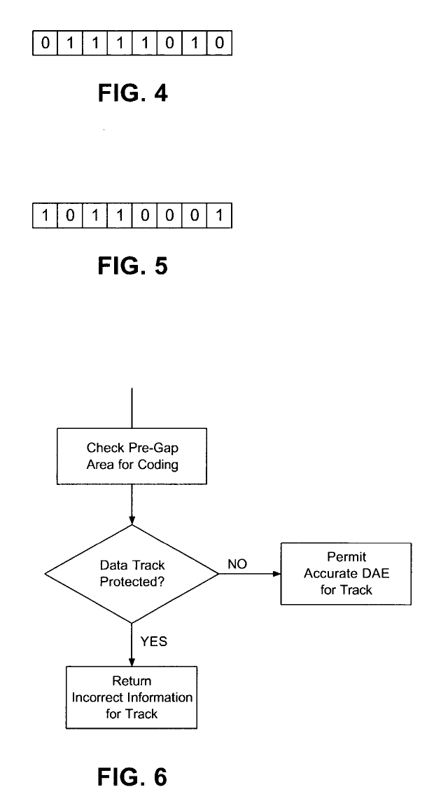

Referring briefly to FIGS. 4 and 5, FIG. 4 represents a sampling of the actual data that may be requested from a protected audio track by a software application such as and MP3 ripping software or CD burning software. FIG. 5 represents the actual data that may be returned to the software application by the specialized driver.

According to one important aspect of the invention, the second data session 22 includes within the single data track 40 the entire work that is provided within the first audio session 20, but in a second, alternative digital format that is different from the digital format that is used in the first audio session 20. In the preferred embodiment, the digital information that is included in the first audio session 20 is in the standard WAV format that is used in industry standard compact audio discs. The alternative digital format of the work in the second data session 22 is preferably provided in a Windows Media WMA format, which is subject to a digital rights management (DRM) protocol.

Referring now to FIG. 3B, at some point after determining that the digital recordation of content 10 contains protected content the executable program will first perform a check to determine whether the digital recordation of content is an original recordation, or an unauthorized copy. If it is determined to be an unauthorized copy, an error message will be produced and the program will refuse to deliver the license and to continue to run.

The executable program will then perform a check to determine whether or not a license is present for the alternative content that is provided in the second data session 22. If no license is present, and the personal computer 18 has an active Internet connection, the executable program will attempt to download a license from a predetermined Internet server. If no Internet connection is available, a temporary license will be granted giving the operator of the personal computer 18 the ability to play the alternative content provided in the second data session 22 a limited number of times.

After ensuring that a license is present the executable program will present a menu to the operator of the personal computer 18, which may be performed by launching the Web browser and providing a user interface in HTML format. The menu will enable the operator to play desired content from the alternative digital format. The operator will also be able to attempt to play the audio content that is contained in the first session, however the content will not have the desired sound quality because of the incorrect data that is being returned by the specialized driver to the software program that is attempting to play the desired audio track.

Although the invention as it has been described with reference to its preferred embodiment is specific to audio files that are contained on compact discs, it should be understood that the invention is equally applicable to other file formats, such as digital video file formats. For example, a DVD containing content such as a movie could be protected against accurate digital extraction by a personal computer by implanting a driver as described above with reference to the preferred embodiment, and an alternative source of the content could be provided an alternative digital file format on a second, data session of the DVD.

In an alternative embodiment of the invention, instead of monitoring the data flow and interfering the drive could be periodically queried to determine what it is doing and what part of the CD it is currently accessing. A command to eject or stop the CD may then be sent to the drive to cancel the data retrieval process.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A digital recordation of content, comprising:
a first session containing a work, said first session being provided in a first digital format; and
a second session also containing said work, said second session being provided in a second digital format that is different than said first digital format.

2. A digital recordation of content according to claim 1, wherein said work is an audio work, and wherein said first digital format is a digital format that is recognizable by consumer audio players.

3. A digital recordation of content according to claim 2, wherein said recordation on said first session comprises a digitally unaltered reproduction of said work.

4. A digital recordation of content according to claim 2, wherein said second session is coded to be recognized by a computer as a data session.

5. A digital recordation of content according to claim 2, wherein said second session comprises means for installing software into a personal computer.

6. A digital recordation of content according to claim 5, wherein said means for installing software is configured to install a device driver into a personal computer.

7. A digital recordation of content according to claim 6, wherein said means for installing software is configured to automatically install the software into the personal computer as an autorun command.

8. A digital recordation of content according to claim 6, wherein said device driver is configured to monitor a data stream between top-level software programs and a hardware device that is appropriate for reading said digital recordation of content.

9. A digital recordation of content according to claim 8, wherein said digital recordation of content comprises a CD, and wherein said device driver is configured to monitor a data stream between top-level software programs and a CD ROM drive in a personal computer.

10. A digital recordation of content according to claim 8, wherein said device driver is configured to monitor SCSI commands to said hardware device.

11. A digital recordation of content according to claim 8, wherein said device driver is constructed and arranged to return incorrect information to the top-level software program in response to a request for digital information from said first session.

12. A digital recordation of content according to claim 11, wherein said device driver is further constructed and arranged to return said incorrect information to the top-level software program without alerting the top-level software program that the information is incorrect.

13. A digital recordation of content according to claim 8, wherein said device driver is further constructed and arranged to determine whether a particular digital recordation of content contains certain predetermined information.

14. A digital recordation of content according to claim 8, wherein said device driver is further constructed and arranged to return incorrect information to the top-level software program in response to a request for digital information from said first session contingent upon a determination that a particular digital recordation of content contains certain predetermined information.

15. A digital recordation of content according to claim 1, wherein said second digital format is encoded using a digital rights management protocol.

16. A digital recordation of content according to claim 1, wherein said second digital format is a Windows media (WMA) file format.

17. A method of operating a personal computer, comprising:
(a) determining whether a digital recordation of content that is readable by a hardware device in the personal computer is protected;
(b) monitoring a data stream between the hardware device and a top-level software program;
(c) if the digital recordation of content is determined to be protected, returning incorrect information to the top-level software program in response to a request for digital information from the digital recordation of content.

18. A method of operating a personal computer according to claim 17, wherein step (c) is performed without alerting the top-level software program that incorrect information is being returned.

19. A method of operating a personal computer according to claim 17, wherein step (b) is performed by monitoring SCSI commands to the hardware device.

20. A method of operating a personal computer according to claim 17, wherein step (a) is performed by determining whether certain predetermined information is contained within the digital recordation of content.

21. A method of operating a personal computer, comprising:
(a) determining whether a digital recordation of content that is readable by a hardware device in the personal computer contains protected material; and
(b) if the digital recordation of content is determined to be protected, directing the personal computer to an alternative source of the content that is protected by a digital rights management protocol.

22. A method of operating a personal computer according to claim 21, wherein step (a) is performed by determining whether certain predetermined information is contained on the digital recordation of content.

23. A method of operating a personal computer according to claim 21, wherein step (a) is performed by determining whether information that is recorded in a first format on the digital recordation of content contains protected material, and wherein step (b) is performed by directing the personal computer to an alternative source of the content that is provided in a second format on the digital recordation of content.

24. A method of operating a personal computer according to claim 23, wherein the first format is a digital audio WAV format.

25. A method of operating a personal computer according to claim 23, wherein the second format is a Windows media WMA format.

26. A method of operating a personal computer according to claim 23, wherein the information that is recorded in a first format is provided on a first session of a CD.

27. A method of operating a personal computer according to claim 23, wherein the information that is recorded in the second format is provided on a second session of a CD.

28. A method of operating a personal computer according to claim 26, wherein said first session is an audio session.

29. A method of operating a personal computer according to claim 27, wherein said second session is a data session.

30. A method of operating a personal computer according to claim 21, further comprising a step of disabling the personal computer from being able to use the protected material.

31. A method of operating a personal computer according to claim 30, wherein said step of disabling the personal computer from being able to use the protected material comprises steps of monitoring and modifying a data stream between software applications in the personal computer and the hardware device.
